(19) United States
(12) Patent Application Publication
(10) Pub. No.: US 2021/0174698 A1
(43) Pub. Date: Jun. 10, 2021

(54) METHODS AND APPARATUS FOR ADAPTIVE COACHING

(71) Applicant: Southwest Human Development, Inc., Phoenix, AZ (US)

(72) Inventor: Mindy Zapata, Phoenix, AZ (US)

(21) Appl. No.: 17/113,219

(22) Filed: Dec. 7, 2020

Related U.S. Application Data
(60) Provisional application No. 62/943,892, filed on Dec. 5, 2019.

(51) Int. Cl. G09B 19/00; G06Q 50/20; G06Q 10/10; G06F 16/22; G06F 3/0482

(52) U.S. Cl. CPC G09B 19/00; G06Q 50/2057; G09B 5/06; G06F 16/22; G06F 3/0482; G06Q 10/10

(57) ABSTRACT

Methods and apparatus for an adaptive coaching system include a remotely accessible coaching module for storing and processing observational data recorded during one or more coaching sessions. Observational data may be entered via a dashboard accessed by a user device. Observational data may then be processed by the coaching module to generate individualized professional development plans and performance reports. The coaching module may also synthesize observational data over a series of coaching sessions against a set of performance metrics to help track and quantify performance improvement over time.

### CROSS-REFERENCES TO RELATED APPLICATIONS

This application claims the benefit of U.S. Provisional Patent Application No. 62/943,892, filed Dec. 5, 2019, and incorporates the disclosure of the application by reference.

### BACKGROUND OF THE TECHNOLOGY

Training systems for teachers, coaches, and other like professionals is largely based on access to other experienced professionals, developed curriculums, and funding. Feedback and performance evaluation are largely performed manually and inconsistently between organizations. This results in high degrees of variability in training, evaluation, and performance monitoring available to teachers, coaches, home visitors/caregivers, and family engagement professionals. Current systems lack the ability to record and document abstract and complex professional practice data in a hands-on, organized, meaningful way.

### SUMMARY OF THE TECHNOLOGY

Methods and apparatus for an adaptive coaching system include a remotely accessible coaching module for storing and processing observational data recorded during one or more coaching sessions. Observational data may be entered via a dashboard accessed by a user device. Observational data may then be processed by the coaching module to generate individualized professional development plans and performance reports. The coaching module may also synthesize observational data over a series of coaching sessions against a set of performance metrics to help track and quantify performance improvement over time.

### BRIEF DESCRIPTION OF THE DRAWINGS

A more complete understanding of the present technology may be derived by referring to the detailed description and claims when considered in connection with the following illustrative figures. In the following figures, like reference numbers refer to similar elements and steps throughout the figures.

FIG. 1 representatively illustrates a block diagram of an exemplary environment for an adaptive coaching system in accordance with an exemplary embodiment of the present technology;

FIG. 2 representatively illustrates a user dashboard for entering data in accordance with an exemplary embodiment of the present technology;

FIG. 3 representatively illustrates a frequency report in accordance with an exemplary embodiment of the present technology;

FIG. 4 representatively illustrates a flow chart of the data collection process in accordance with an exemplary embodiment of the present technology; and

FIG. 5 representatively illustrates a flow chart of the data processing system in accordance with an exemplary embodiment of the present technology.

Elements and steps in the figures are illustrated for simplicity and clarity and have not necessarily been rendered according to any particular sequence. For example, steps that may be performed concurrently or in a different order are illustrated in the figures to help to improve understanding of embodiments of the present technology.

### DETAILED DESCRIPTION OF EXEMPLARY EMBODIMENTS

The present technology may be described in terms of functional block components and various processing steps. Such functional blocks may be realized by any number of components configured to perform the specified functions and achieve the various results. For example, the present technology may employ various types of computing platforms and memory storage systems configured to operate over various types of communication networks, which may carry out a variety of operations suited to processing various types of intelligence information. In addition, the embodiments described are merely exemplary applications for the technology. Further, the present technology may employ any number of conventional techniques for data storage and retrieval, reporting, or otherwise managing data.

A system and method for an adaptive coaching system according to various aspects of the present technology may operate in conjunction with any type of computing system, application server, data storage system, or the like. Various representative implementations of the present technology may be applied to any system for managing observed professional practices such as teaching techniques, use of tools, interaction, and/or the proficiency of use of these factors.

The present technology may involve multiple programs, functions, computing devices (such as client computers and/or servers), and the like. While the exemplary embodiments are described in conjunction with conventional computing devices, the various elements and processes may be implemented in hardware, software, or any combination of hardware, software, and other systems. Further, the present technology may employ any number of conventional techniques for generating and/or analyzing collected information, interfacing a computing device to a network, transmitting and/or receiving data, providing a user interface, communicating information, interfacing with a user, detecting and/or analyzing input to a computing device, gathering data, and the like.

A user device may comprise conventional computing components, such as a processor, a local memory such as RAM, long term memory such as a hard disk, solid-state drive, or electronic non-volatile computer storage medium, a network adaptor, and any number of input and/or output devices such as a keyboard, mouse, monitor, touch screen, microphone, speaker, motion sensor, orientation sensor, light sensor, and the like. The various memories of the computing device may facilitate the storage of one or more computer instructions, such as a software routine and/or software program, which may be executable by the processor to perform one or more methods, processes, and/or steps of the disclosed technology. The computing device may comprise any suitable device or system such as: a personal computer, server, mobile phone, smart phone, tablet computer, kiosk, portable computer, and the like.

Further, databases, systems, and/or components of the present technology may comprise any combination of databases, systems, and/or components at a single location or at multiple locations. Each database, system, and/or component of the present technology may comprise any suitable security features, such as one or more firewalls, access codes, encryption, de-encryption, compression, decompression, and/or the like. Systems and methods according to the present technology may comprise one or more databases configured to store data according to the present technology. In some embodiments, data may be shared and/or linked among the various databases. The one or more databases may be implemented using database schemes such as IBM DB2, Oracle, MySQL, and/or Microsoft SQL Server, or any other database scheme, whether now known or later developed. Transferring data to and from the one or more databases may be accomplished using a communicative coupling, for example a network connection to the Internet or a local area network (LAN).

The present technology may be embodied as a method, a system, a device, and/or a computer program product. Accordingly, the present technology may take the form of an entirely software embodiment, an entirely hardware embodiment, or an embodiment combining aspects of both software and hardware. Furthermore, the present technology may take the form of a set of instructions, such as a computer program product, for causing a processor and/or computing device to perform a desired function, stored on a non-transitory computer-readable storage medium having computer-readable program code embodied in the storage medium. Any suitable computer-readable storage medium may be utilized, including, but not limited to, hard disk drive, CD-ROM, optical storage devices, magnetic storage devices, USB memory devices, any appropriate volatile or non-volatile memory system, and the like or any combination thereof. The present technology may take the form of a downloadable and/or cloud-based non-downloadable computer program product, and/or software as a service (SAAS) product.

Software and/or software elements according to various aspects of the present technology may be implemented with any programming, scripting, or computer language or standard, such as, for example, AJAX, C, C++, Java, JavaScript, COBOL, assembly, PERL, eXtensible Markup Language (XML), PHP, CSS, HL7, GNU Mathematical Programming Language (GMPL), etc., or any other programming and/or scripting language, whether now known or later developed. Further, the present technology may be used in conjunction with a computing device running any operating system such as any version of Windows, MacOS, OS/2, BeOS, Linux, UNIX, Android, iOS, or any other operating system, whether now known or later developed, and the present technology may be used in conjunction with any software application operating on such a computing device.

In addition, the present technology may employ any number of conventional techniques for data transmission, signaling, data processing, network control, and the like. Computing devices according to various aspects of the present technology may communicate with each other by one or more telecommunication networks. The telecommunication network may comprise a collection of terminal nodes, links, and any intermediate nodes which are connected to enable communication (including transfer of data) at a distance between the terminal nodes. In some embodiments, a terminal node may comprise a computing device. The telecommunication network may comprise any suitable communication system, such as the Internet, an intranet, an extranet, WAN, LAN, Bluetooth, satellite communications, cellular radio network, wireless network, telephone network, cable network, and the like. Moreover, computing devices according to various aspects of the present technology may communicate over the telecommunication network using TCP/IP, HTTP, HTTPS, FTP, IPX, AppleTalk, IP-6, NetBIOS, OSI, and/or any number of existing or future protocols. The telecommunication network may be simply referred to as a network.

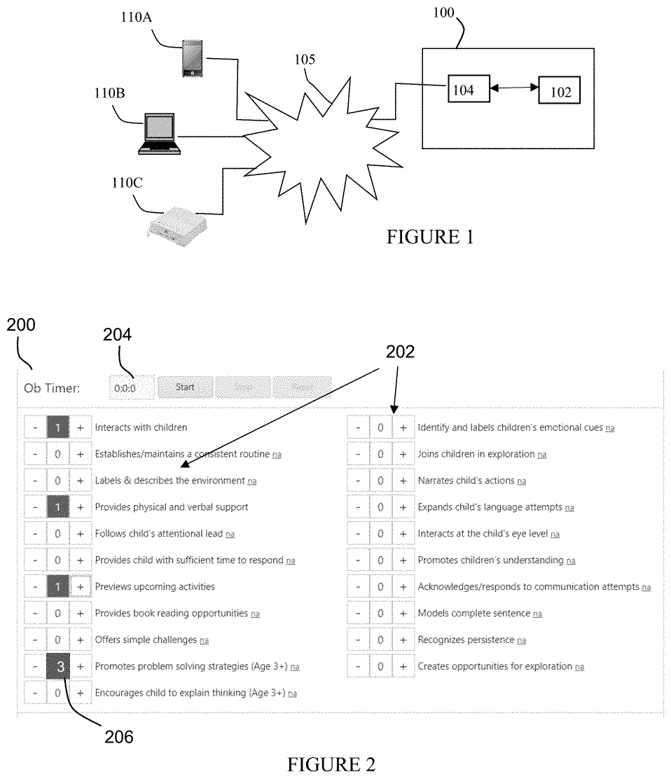

Referring now to FIG. 1, an adaptive coaching system 100 may comprise a coaching module 102 and an observer module 104 configured to communicate with one or more user devices 110 over a communication network 105. The coaching module 102 may generally comprise a professional practice data library, an observation library, and a training library.

The user device 110 comprise any suitable device for interfacing with the coaching module, such as a mobile device 110A like a smartphone or tablet computing device, a personal computer 110B, or a data kiosk 110C. The user device 110 may run applications locally or remotely such that the user device 110 operates as a terminal, or applications may run cooperatively between the user device 110 and other systems, such as the user device 110 and the coaching module 102 operating in a client-server configuration.

The observer module 104 may be configured to generate a dashboard or other user interface comprising one or more data entry screens on the user device 110 to allow the user to interact with the adaptive coaching system 100. The dashboard 200 may also be configured to collect real-time observational data from the observer on factors such as: session time, coach specific goals for a session, tools/processes used by the coaching professional, observer and coaching professional interactions, and observed coaching professional actions. Referring now to FIG. 2, in one embodiment the dashboard 200 may prompt an observer (e.g. coach) to record precise attributes of the coaching professional's (e.g. teacher, home visitor, or family engagement professional) actions within the adaptive coaching system on an electronic form. For example, during a coaching session, the observer/coach may be able to select from a predetermined list of professional practices 202 and attributes observed during the session. The observer may also be able to identify the frequency which a particular professional practice 206 is observed and set a timer 204 to record how long the coaching session lasts. Additional factors that the observer may be able to include in the observational data include dose, duration, activity, model, feedback, refection, professional planning data, and any other suitable criteria for quantifying performance against a set of metrics.

At the end of a session, the electronic form may be uploaded to the coaching module 102 so that the entered observational data can be processed. The coaching module 102 may use the observational data collected in the electronic form to generate one or more reports directed towards evaluating the session and providing feedback to the coaching professional and other predetermined users directed towards improving the coaching professional's professional development. More specifically, the coaching module 102 may analyze the uploaded observational data to generate individualized professional development plans from the training library for the coaching professional. The professional development plans or other reporting metrics may be generated as the observational data is uploaded such that any generated professional development plan or other report may be immediately available to the coaching professional, the observer, or other users with access to the processed data.

The observation library may store a plurality of electronic forms that correspond to a particular type of coaching session. For example, types of coaching sessions may include: in-person or virtual sessions, directed towards a particular age group or age range, a particular method of teaching, a desired goal, and the like. The observation library may also be configured to store a list of specific attributes or professional practices 202 associated with each type of coaching session. In this way, when a given type of coaching session is selected by the user from the dashboard, the observation library may be configured to display an electronic form with a listing of professional practices 202 that are specific to that type of session.

The professional practice data library may comprise data relating to specific coaching professionals, groups of coaching professionals, organizations, the uploaded observational data, generated reports and professional development plans. The dashboard may allow the user to access one or more sets of data stored in the professional practice data library. For example, a coaching professional may be able to access their personal professional development plan from their personal user device via the dashboard. The coaching professional may also be able to use the dashboard to access training materials identified in their professional development plan.

The training library may comprise a set of predetermined or individualized professional development plans that can be used by the coaching module 102 to generate individualized development plans directed towards the development of job embedded skills, habits, and practices of professionals that have been associated with the effective current job performance in education and family work. The training library may also comprise training materials directed towards supporting the development plans such as instructional videos, lesson materials, and the like which may be accessed by the coaching module 102 and the observer module 104.

The collected observational data may be analyzed in real-time by the coaching module 102 to provide the coaching professional immediate and specifically targeted feedback about their work so that they may improve their capacity and proficiency as a professional. The adaptive coaching system 100 also chronicles the outcome of the embedded professional development experience between a coach and a coaching professional so that it may be utilized within other supervisory of organizational communication aimed at supporting teachers, home visitors, or family engagement staff. The adaptive coaching system 100 may be configured to resolve problems associated with systematic professional development documentation by defining specific parameters or desired metrics of professional practices and comparing how a given coaching professional or organization is performing against the defined metrics.

The adaptive coaching system 100 additionally enables users to record and document abstract and complex professional practice data in a hands-on, organized, meaningful way. Highly effective teacher/family worker practices may be translated into practical workforce strategies that can be professionally taught, recorded, quantified and qualified over a set period of time. Progress of a coaching professional may be tracked by the coaching module 102 and can be quantified with every coaching visit entered into the adaptive coaching system 100. For example, the coaching module 102 may use the timing system 204 to more accurately track how much time a coaching professional spends on a given task. The timing system 204 may be used to measure a given coaching professional's performance relating to a particular task/goal against a set of predetermined performance metrics. This measurement may be used to help adapt the individualized professional development plan and help direct how each coaching professional approach subsequent coaching sessions.

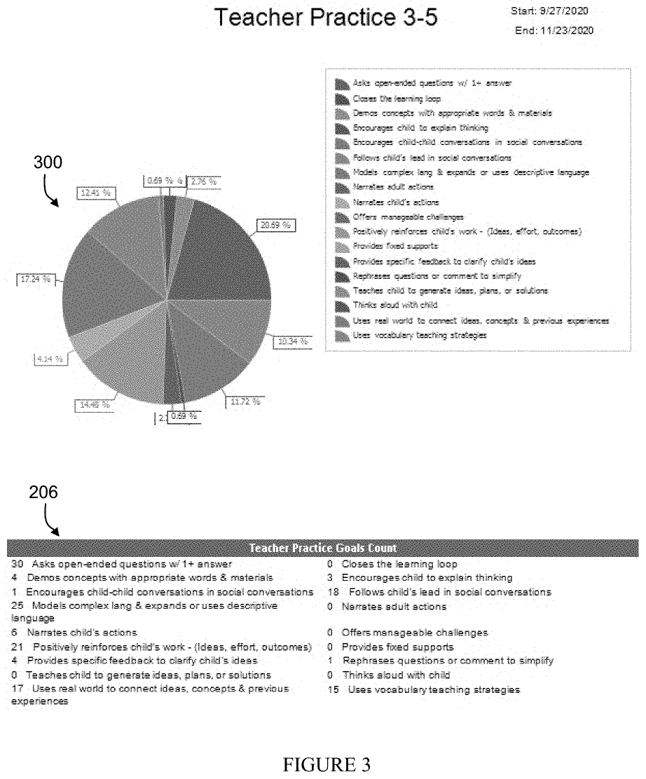

The coaching module 102 may also be configured to analyze the frequency at which a coaching professional uses specific professional practices to determine a level of proficiency for each professional practice. The results may be used to indicate which professional practices a given coaching professional has mastered and those which can be improved. The coaching module 102 may generate a report, graph, or chart to help visualize for the coaching professional the results of the analysis. For example, and referring now to FIG. 3, a frequency chart 300 may be generated based on the identified number of particular professional practices 206 observed during one or more coaching sessions. The frequency chart 300 may be used by the coach and/or coaching professional to identify one or more types of professional practices 202 that can be targeted for improvement.

The coaching module 102 may also be configured to provide specific suggestions on improvement or training opportunities for one or more coaches based on the analysis of the collected observational data relating to their performance. For example, based on a review of the uploaded forms for a given coaching professional, the coaching module 102 may determine that the coaching professional needs additional training in one or more areas to improve a coaching professional's efficacy against any suitable criteria such as performance, engagement, encouragement, or the like. The coaching module 102 may then generate a list of training videos stored in the training library for the coaching professional to review. Any training opportunities identified by the coaching module 102 may be unique and/or tailored to each coaching professional. For example, the coaching module 102 may have access to a coaching professional's schedule of upcoming coaching sessions and may prioritize a set of training materials specifically targeted to the type of coaching sessions scheduled.

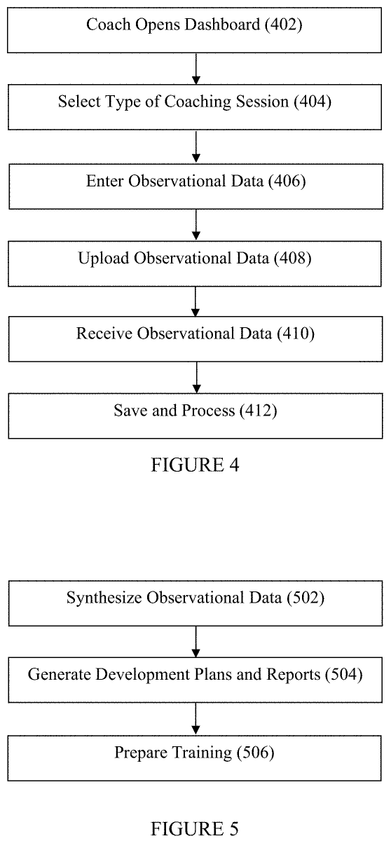

Referring now to FIG. 4, in operation an observer or coach may initiate an observation of a coaching session by opening the dashboard (402) to access an appropriate electronic form for the type of coaching session being observed (404). As the coach is observing the coaching professional conduct the coaching session, the coach may record observational data into the electronic form (406). At the end of the coaching session, the observer may upload the recorded observational data to the coaching module 102 for processing (408).

After the coaching module receives the uploaded observational data (410), the system may perform a set of initial processing steps to prepare the received data for viewing or access (412). For example, the coaching module 102 may prepare a summary of the coaching session for review by the coaching professional immediately after the observational data has been uploaded.

Referring now to FIG. 5, subsequently, the coaching system may perform a set of more detailed analyses by combining the uploaded observational data with any preexisting data for the coaching professional (502). The newly updated data set may be used to generate a new individualized professional development plan or update an existing individualized professional development plan based on the newly added data (504). The coaching module 102 may also use the newly updated data set to generate other reports either automatically or in response to a query from a user. The coaching module 102 may also generate a set of training recommendations for the coaching professional based on the observational data (506).

As used herein, the terms “comprises,” “comprising,” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present technology, in addition to those not specifically recited, may be varied or otherwise particularly adapted to specific environments, manufacturing specifications, design parameters or other operating requirements without departing from the general principles of the same.

The present technology has been described above with reference to exemplary embodiments. However, changes and modifications may be made to the exemplary embodiments without departing from the scope of the present technology. These and other changes or modifications are intended to be included within the scope of the present technology, as expressed in the following claims.

1. An internet-based adaptive coaching system accessible by a user device connected to the internet via a network, comprising:
a coaching module, comprising:
a professional practice data library;
an observation library; and
a training library; and
an observer module communicatively linked to the coaching module and the user device and configured to:
display a dashboard on the user device;
allow a user to enter observational data from the user device during a coaching session conducted by a coaching professional by:
selecting a type of coaching session being observed by the user from the dashboard;
selecting a number of observed professional practices from a set of available professional practices in the observation library displayed on the dashboard; and
recording a duration of the coaching session; and
upload the entered observational data to the coaching module,
wherein the coaching module is configured to:
store the uploaded observational data in the professional practice data library;
quantify the uploaded observational data; and
analyze the uploaded observational data to generate individualized professional development plans from the training library for the coaching professional.

2. An internet-based adaptive coaching system according to claim 1, wherein the set of available professional practices displayed to the user is determined according to the type of coaching session selected.

3. An internet-based adaptive coaching system according to claim 1, wherein the selecting a number of observed professional practices includes a quantity of observations for each individual practice available for selection.

4. An internet-based adaptive coaching system according to claim 1, wherein the coaching module is further configured to prompt the coaching professional to view a training session prior to a coaching session, wherein the training selection is determined by the coaching module based on the generated individualized professional development plan for the coaching professional.

5. An internet-based adaptive coaching system according to claim 4, wherein performance of the coaching professional to the generated individualized professional development plan for the coaching professional is determined according to a set of predetermined performance metrics.

6. An internet-based adaptive coaching system according to claim 1, wherein the coaching module is further configured to generate professional development plans for an organization based upon uploaded observational data for each coaching professional associated with the organization.

7. An internet-based adaptive coaching system according to claim 1, wherein the coaching module is further configured to display the quantified observational data to the user according to a set of selected criteria.

8. An adaptive coaching system accessible by a user device, comprising:
a coaching module, comprising:
a professional practice data library;
an observation library; and
a training library; and
an observer module comprising a dashboard communicatively linked to the coaching module and the user device and configured to:
allow a user to enter observational data from the user device during a coaching session conducted by a coaching professional by:
selecting a type of coaching session being observed by the user from the dashboard;
selecting a number of observed professional practices from a set of available professional practices in the observation library displayed on the dashboard; and
recording a duration of the coaching session; and
upload the entered observational data to the coaching module,
wherein the coaching module is configured to:
store the uploaded observational data;
quantify the uploaded observational data; and
analyze the uploaded observational data to generate individualized professional development plans from the training library for the coaching professional.

9. An adaptive coaching system according to claim 8, wherein the set of available professional practices displayed to the user is determined according to the type of coaching session selected.

10. An adaptive coaching system according to claim 8, wherein the selecting a number of observed professional practices includes a quantity of observations for each individual practice available for selection.

11. An adaptive coaching system according to claim 8, wherein the coaching module is further configured to present a training session to the coaching professional prior to a coaching session according to the generated individualized professional development plan for the coaching professional.

12. An adaptive coaching system according to claim 11, wherein performance of the coaching professional to the generated individualized professional development plan for the coaching professional is determined according to a set of predetermined performance metrics.

13. An adaptive coaching system according to claim 8, wherein the coaching module is further configured to generate professional development plans for an organization based upon uploaded observational data for each coaching professional associated with the organization.

14. An adaptive coaching system according to claim 8, wherein the coaching module is further configured to display the quantified observational data to the user according to a set of selected criteria.

15. A method for generating adaptive coaching plans, comprising:
receiving observational data entered from a user device communicatively linked to a coaching module during a coaching session conducted by a coaching professional;
uploading the entered observational data to the coaching module, wherein the coaching module is configured to:
store the uploaded observational data;
quantify the uploaded observational data; and
analyze the uploaded observational data to generate individualized professional development plans from the training library for the coaching professional.

16. A method for generating adaptive coaching plans according to claim 15, wherein entering observational data comprises:
selecting a type of coaching session being observed by the user;
selecting a number of observed professional practices from a set of available professional practices in the observation library displayed on the user device; and
recording a duration of the coaching session.

17. A method for generating adaptive coaching plans according to claim 16, wherein the set of available professional practices displayed to the user is determined according to the type of coaching session selected.

18. A method for generating adaptive coaching plans for according to claim 15, wherein the coaching module is further configured to present a training session to the coaching professional prior to a coaching session according to the generated individualized professional development plan for the coaching professional.

19. A method for generating adaptive coaching plans for according to claim 18, wherein performance of the coaching professional to the generated individualized professional development plan for the coaching professional is determined according to a set of predetermined performance metrics.

20. A method for generating adaptive coaching plans for according to claim 15, wherein the coaching module is further configured to display the quantified observational data to the user according to a set of selected criteria.
